(19) United States
(12) Patent Application Publication
(10) Pub. No.: US 2015/0144225 A1
(43) Pub. Date: May 28, 2015

(54) DEBARKING BLADE ARRANGEMENT

(71) Applicant: Deere & Company, Moline, IL (US)

(72) Inventors: Henry J. Stulen, Paris (CA); Benjamin DiSabatino, Brantford (CA)

(21) Appl. No.: 14/090,681

(22) Filed: Nov. 26, 2013

(51) Int. Cl. B27L 1/10; A01G 23/083

(52) U.S. Cl. CPC B27L 1/10; A01G 23/083
USPC 144/208.91

(57) ABSTRACT

A debarking blade arrangement is carried by a frame of a tree harvesting head and includes a fixed knife segment that cooperates with three articulated knife segments carried by each of right- and left-hand, articulated debarking arm assemblies which are disposed on opposite sides of a tree stem feed axis. Each arm assembly includes a rear arm section that carries a first knife segment, an intermediate arm section and a front arm section that carries second and third knife segments and is yieldably biased toward the intermediate arm section so as to dispose the second and third knife segments for engagement with a tree stem. A hydraulically-powered arrangement is coupled to each arm assembly for selectively pivoting the entire assembly about a fixed axis and for pivoting the intermediate and front arm sections relative to the rear arm section for keeping the knife segments in debarking engagement with the stem.

### FIELD OF THE INVENTION

The present invention relates to a debarking assembly for a tree harvester head and more particularly relates to a debarking blade arrangement for removing the bark from various species of trees including eucalyptus trees

### BACKGROUND OF THE INVENTION

The amount of high yield, fast growing eucalyptus plantations has been growing and will continue to increase in South America and the Asia Pacific Region. It is important when harvesting eucalyptus to be able to remove the tree limbs and greater than 95% of the bark from the stem when it is felled and processed into log lengths. The bark is removed by first cutting/scoring it with special drive wheels and then rubbing with knives to shave the bark off. It is difficult to achieve the circumferential stem coverage (contact) from the base to top end diameters of the stem needed to accomplish complete debarking with a single curved shape knife, although this is the current practice. Results are adequate in the wet season but are not acceptable in the dry season during which debarking is more difficult since the absence of moisture results in the bark adhering to the cambium layer of the tree stem. The current solution to the dry season problem is to repeatedly cycle the stem through the head (three to five times) which can result in stem damage and consequent fiber loss.

U.S. Pat. No. 3,941,174 discloses supporting a plurality of delimbing and debarking knife segments respectively on a plurality of links of a pair of flexible chain sections. The flexible chain sections are each mounted with one end secured to the harvester head frame and another end secured to an end of an arm that is moved by a hydraulic cylinder for moving the chain section into engagement with a tree stem being delimbed and debarked.

### SUMMARY OF THE INVENTION

Accordingly, it is a particular object of the invention to provide a rugged debarking knife arrangement including a plurality of knife segments mounted to right- and left-hand arm assemblies constructed and powered in such a way that the knife segments closely embrace a tree stem and maintain substantially complete circumferential engagement (coverage) of the stem as the stem diameter changes during debarking operation when the stem is moved longitudinally relative to the debarking knife arrangement.

This object is carried out by a debarking knife arrangement including articulated arm assemblies to each of which is pivotally mounted a plurality of debarking knife segments.

These and other objects of the invention will become apparent from a reading of the ensuing description together with the appended drawings.

### BRIEF DESCRIPTION OF THE DRAWINGS

FIG. 1 is a right bottom perspective view of a tree harvesting head equipped with a debarking knife assembly constructed in accordance with the principles of the present invention.

FIG. 2 is a top right perspective view of the harvesting head shown in FIG. 1.

FIGS. 3-5 are top views of the debarking knife assembly respectively showing it in a fully open position, an intermediate position and a fully closed position.

### DESCRIPTION OF THE PREFERRED EMBODIMENT

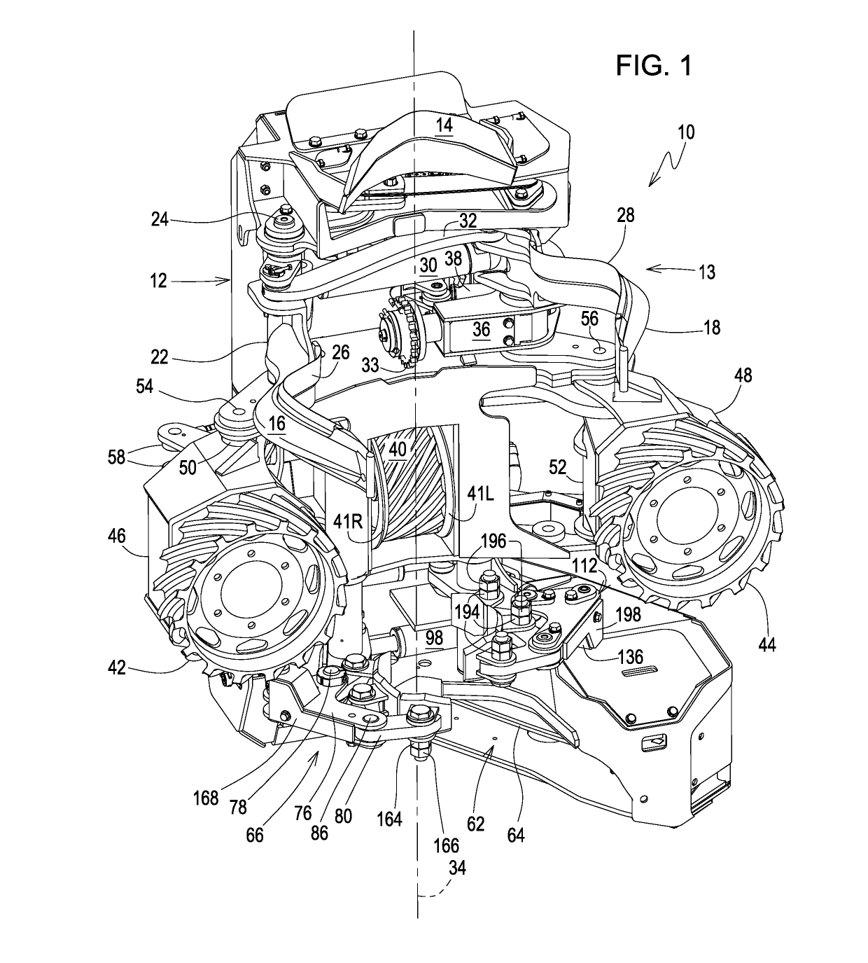

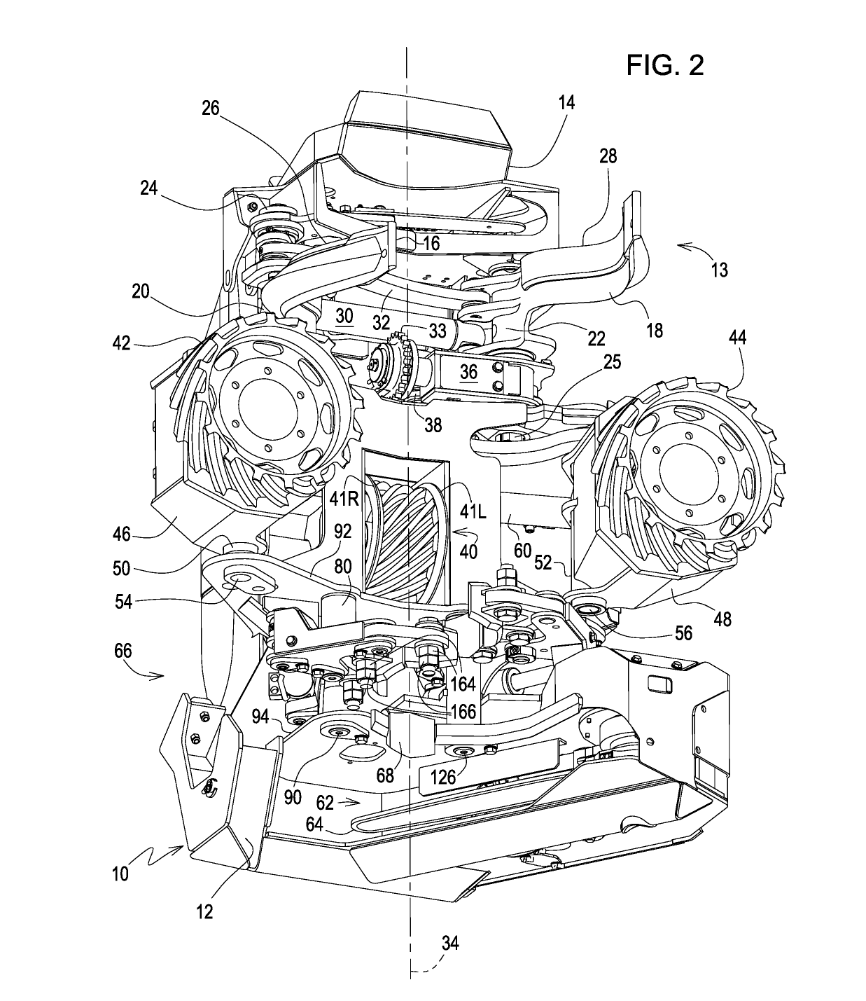

Referring now to FIGS. 1 and 2, there is shown a tree harvesting head 10 of the type adapted to be carried at the end of an articulated boom (not shown) carried by a mobile chassis (also not shown). The harvesting head 10 is capable of grappling, felling, delimbing, debarking and cutting a tree stem into one or more logs of predetermined length.

Many of the features of the tree harvesting head 10 are the same as, or similar to, features of the tree harvesting head disclosed in commonly assigned U.S. Pat. No. 8,002,004 having an issue date of Aug. 23, 2011, the disclosure of which is incorporated by reference herein in its entirety.

The harvesting head 10 includes a main support frame 12, here shown in a substantially upright harvesting position, which it would occupy when the head is positioned against a tree stem to be severed from the ground. The harvesting head would be pivotally mounted to a support boom, or the like (not shown) by a yoke or hanger (not shown) for movement between the upright position and a substantially horizontal tree stem processing position once the tree stem is severed from the ground. The head 10 is designed to pivot under its own weight, or its own weight plus that of a stem that has just been felled, from its upright position to the processing position. A hydraulic cylinder (not shown) is coupled between the frame 12 and the yoke or hanger and is configured for pivoting the head 10 back to the harvesting position from the processing position.

A delimbing blade arrangement 13 is mounted to an upper region of the support frame 12 and includes a curved delimbing knife 14 that is forwardly concave and fixed, as by welding, to a central top location between opposite sides of the frame 12. In other embodiments, the knife 14 may be mounted to the frame 12 for movement relative thereto about a pivot or guide toward and away from a tree stem held by the head 10 so as to float on and thus follow the contour of the tree stem. When the head 10 is oriented in its processing position, movement of the floating knife toward a central axis of the tree stem may occur under the force of gravity and movement away from the tree stem axis may occur due to changes in the shape of the tree stem. The blade arrangement 13 further includes right- and left-hand arms 16 and 18, respectively, having end sections including upright tubular sleeves 20 and 22 pivotally received on right- and left-hand cylindrical posts 24 (FIG. 1) and 25 (FIG. 2) fixed to the frame 12 at respective locations below and to opposite sides of the fixed knife 14. The arms 16 and 18 respectively carry delimbing knives 26 and 28 and are shown in an open position wherein they project forwardly from the frame 12 for permitting the frame 12 to be placed so that the fixed delimbing knife bears against a tree stem being harvested with the arms 16 and 18 together with knives 26 and 28 being located at opposite sides of the stem. The arm 16 and knife 26, and the arm 18 and knife 28 are configured for cooperating with the fixed knife 14 so as to embrace a tree stem as the latter is fed lengthwise along the tree stem central axis, and, hence, is fed lengthwise along a feed axis 34 of the support frame during processing.

Provided for selectively opening and closing the arms 16 and 18 together with the knives 26 and 28 relative to a tree stem located between the arms is a single hydraulic cylinder 30 having its opposite ends respectively pivotally coupled to mounting ears joined to the tubular sleeves 20 and 22 of the end sections of the right- and left-hand arms 16 and 18, with a timing link 32 also having opposite ends respectively pivotally coupled to respective mounting ears joined to the arm end sections 20 and 22.

Positioned just below the delimbing arms 16 and 18 is a toothed length-measurement wheel 33 for engaging the same side area of a tree stem that is engaged by the fixed delimbing knife 14 when the stem is being advanced lengthwise of the frame 12 along a feed axis 34 during processing. The rotation of the wheel 33 is sensed, for example by a rotary potentiometer, and used to determine timber length in a well-known manner. The wheel 33 is coupled to the end of a shaft which is rotatably mounted in a housing 36 mounted for being pivoted about the left-hand post 25 about which the left arm 18 pivots. A hydraulic wheel control cylinder 38 is connected between the frame 12 and the housing 36 for selectively pivoting the wheel 32 to a retracted position, wherein it is positioned so as not to be contacted by a tree stem being harvested, and a fully-deployed position for engaging a stem to be processed. The operation of the wheel control cylinder 38 can be automatically initiated in a manner explained below.

Provided for propelling a tree stem along the feed axis 34 are spirally ribbed central, right-hand and left-hand feed wheels 40, 42 and 44, respectively. The central feed wheel 40 is mounted at a central location of the frame 12 below the length-measurement wheel 33 for being driven in rotation about a fixed axis disposed transversely to, and behind the feed axis 34, which, for a point of reference, is considered to be forward of the frame 12. Opposite circular ends of the central feed wheel 40 respectively define right- and left-hand circular knife edges 41R and 41L having a purpose stated below. The feed wheels 42 and 44 are respectively mounted to first ends of right- and left-hand wheel arms 46 and 48 for being rotatably driven about fore-and-aft extending axes located at opposite sides of the feed axis 34, with rear ends of the arms 46 and 48 being respectively defined by upright sleeves 50 and 52 received for pivoting about posts 54 and 56. Right- and left-hand wheel arm cylinders 58 and 60 are respectively mounted between the frame 12 and the arms 46 and 48 for selectively swinging the arms relative to the feed axis 34 between an open position, as shown in FIG. 2, wherein the feed wheels 42 and 44 are spaced outside a tree stem receiving zone along the feed axis 34, and a closed position, wherein the feed wheels are engaged with a tree located within the tree receiving zone. The orientation of the ribs on the feed wheels 40, 42 and 44 is such that, when a tree stem is grasped by the feed wheels 42 and 44 and pressed against the feed wheel 40, the stem is rotated about its longitudinal axis with the knife edges 41R and 41L of the central feed wheel 40 acting to cut or score the bark in preparation for the debarking operation. While three feed wheels having surfaces defined by spiral ribs are disclosed herein, in other embodiments, a different number of feed wheels, two or four, for example, may be used and their surfaces may be defined by any desired stem-gripping means including spikes, pyramid shapes, or the like.

During felling operation, the right- and left-hand arms 16 and 18 serve as grapple arms for grasping a stem of a standing tree being harvested. Also aiding in grasping the stem are the feed wheels 42 and 44 which are moved into tight engagement with the standing tree stem. Mounted to a location adjacent the bottom of the frame 12 for severing a stem from the ground, once such a stem is in the grasp of the arms 16 and 18, and of the feed wheels 42 and 44 so as to position the central axis of the tree stem generally along the feed axis 34, is a felling saw 62, configured as a chain saw including a cutting bar 64 mounted for being selectively pivoted between a retracted position, as shown in FIG. 1, wherein it is located along one side of the zone for containing a tree stem to be harvested and/or processed, and an extended position wherein the cutting bar 36 has traversed the zone. While holding the felled tree, the head 10 pivots, by the action of gravity, under its own weight plus that of the felled tree, from its upright harvesting position to its generally horizontal processing position. Skilled operators sometimes begin processing as the head 10 together with the felled tree is moving between the harvesting and processing positions.

Debarking of a tree stem being processed is carried out by a debarking blade arrangement 66 mounted to the frame in a region below the central feed wheel 40 and above the path followed by the chain saw bar 64 when it severs a tree stem. The purpose of the debarking blade arrangement 66 is to achieve a high percentage of circumferential stem contact with debarking knives and maintain this contact with near constant force as the stem diameter changes as the central axis of the tree stem is moved along the feed axis 34 during processing.

The debarking blade arrangement 66 includes a stationary debarking knife 68 (see FIG. 2), which like the knife 14 of the delimbing blade arrangement 13, is fixed, as by welding, to a central location of the frame 12 and is offset towards the central axis of the tree stem relative to the fixed delimbing knife 14

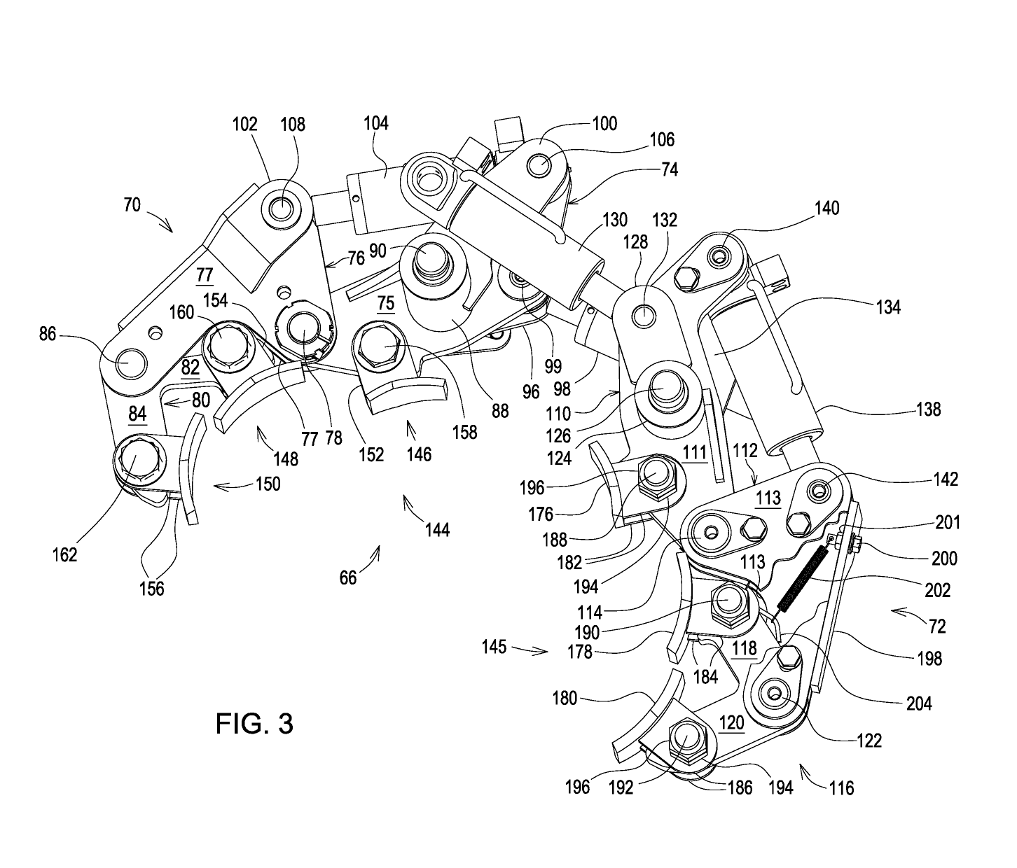

Referring now also to FIGS. 3-5, it can be seen that the debarking blade arrangement 66 further includes right- and left-hand articulated debarking arm assemblies 70 and 72, respectively, which are constructed of flat plates, but need not be.

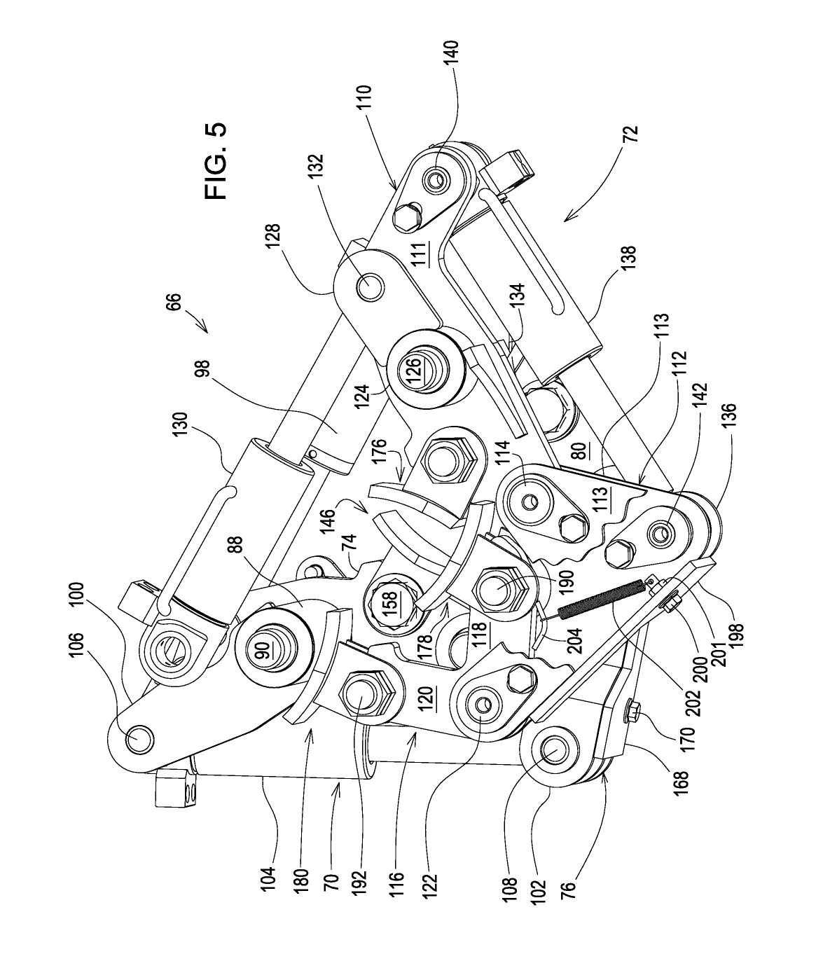

The right-hand debarking arm assembly 70 includes a rear arm section 74, a generally triangular intermediate arm section 76, constructed of substantially identical parallel, upper and lower plates 77, and having one corner pivotally coupled, as at an articulation pin 78 to a front end of the rear arm section 74, and a V-shaped front arm section 80 having inwardly diverging limbs 82 and 84 joined at a corner pivotally coupled, as by an articulation pin 86, to a front corner of the intermediate arm section 76. The rear arm section 74 is defined, in part, by a generally triangular, horizontal, middle plate 75 that includes a central region between front and rear corners respectively defining its opposite ends fixed to an upright sleeve 88 received for pivoting about a vertical pivot post 90 having an upper and lower ends respectively anchored to upper and lower horizontal plates 92 and 94, which form part of the frame 12. A horizontal lower plate 96 of the arm section 74 has one end that is fixed to the sleeve 88 and extends inwardly to the rear from the sleeve 88 in parallel spaced relationship to the middle plate 75 to a location spaced vertically below an inner corner of the middle plate 75. An articulated arm control hydraulic cylinder 98 has a first end pivotally coupled to a leftward location (not shown) of the frame 12 and has a second end located between, and pivotally coupled to, the middle and lower plates 75 and 96, respectively, of the arm section 74 by a pivot pin 99 (FIG. 3). When the hydraulic cylinder 98 is fully retracted, as shown in FIG. 3, the rear arm section is pivoted clockwise a maximum amount about the pivot post 90, and when the hydraulic cylinder 98 is fully extended, as shown in FIG. 5, the rear arm section 74 is pivoted counterclockwise a maximum amount about the pivot post 90. An upper plate 100 of the arm section 74 is spaced vertically above the middle plate 75 and has a forward end fixed to the sleeve 88 from which the plate 100 projects to the rear in parallel relationship to the middle plate 75, with the rear end of the upper plate being disposed vertically above the rear corner of the plate 75. An angled tab 102 has an upwardly and rearwardly angled rear portion joined at one end to the intermediate arm section 76 and joined at another end to a rear tab portion that extends in spaced parallel relationship to the arm section 76 to a location above an outer corner of the section 76. An articulated arm section control hydraulic cylinder 104 has a first end disposed between, and pivotally coupled to, the rear end of the upper plate 100 and rear corner of the middle plate of rear arm section 74 by a pivot pin 106. A second end of the hydraulic cylinder 106 is disposed between, and pivotally coupled to, the tab 102 and outer corner of the intermediate arm section 76 by a pivot pin 108. When the hydraulic cylinder 104 is fully retracted, as shown in FIG. 3, the intermediate arm section 76 is pivoted clockwise a maximum amount about the articulation pin 78, and when the hydraulic cylinder 104 is fully extended, as shown in FIG. 5, the intermediate arm section 74 is pivoted counterclockwise a maximum amount about the articulation pin 78.

The left-hand articulated debarking arm assembly 72 is substantially a mirror image of the right-hand assembly 70 and includes a rear arm section 110, a generally triangular intermediate arm section 112, formed of substantially identical, parallel upper and lower plates 113 and having one corner pivotally coupled to a front end of the rear arm section 110 by an articulation pin 114, and a V-shaped front arm section 116 having inwardly diverging limbs 118 and 120 joined at the bottom of the V which is pivotally coupled, as at an articulation pin 122, to an outer corner of the intermediate arm section 112. The rear arm section 110 includes a middle horizontal plate 111 having a central region between its front end and a rear end fixed to a middle location between opposite ends of an upright sleeve 124 received for pivoting about a vertical pivot post 126 having an upper and lower ends respectively anchored to the upper and lower horizontal plates 92 and 94. The rear arm section 110 also includes an upper plate 128 spaced above in parallel relationship to the middle plate 111 and having a front end that is fixed to the sleeve 124 from which the plate 128 projects rearward to a location above an inner region of the middle plate 111 of the arm section which is between the sleeve and rear end of the middle plate 111.

A hydraulic articulated arm control cylinder 130 has a first end pivotally coupled (not shown) to a right side region of the frame 12 and has a second end located between, and pivotally coupled to, the middle and upper plates 111 and 128, respectively, of the arm section 110 by a pivot pin 132. When the hydraulic cylinder 130 is fully retracted, as shown in FIG. 3, the rear arm section 110 is pivoted counterclockwise a maximum amount about the pivot post 126, and when the hydraulic cylinder 130 is fully extended, as shown in FIG. 5, the rear arm section 74 is pivoted clockwise a maximum amount about the pivot post 126. A lower plate 134 (FIGS. 3 and 5) is fixed to, and projects to the rear from, the sleeve 124 in vertically spaced, parallel relationship to the middle plate 111 of the rear arm section 110, and a tab 136 (partially visible in FIGS. 1 and 5) has an end joined to the bottom plate 113 of the intermediate arm section 112 and extends in spaced parallel relationship to the arm section 112 to a location above an outer corner of the bottom plate 113. An articulated arm section control hydraulic cylinder 138 has a first end disposed between, and pivotally coupled to, rear ends of the lower plate 134 and the middle plate of the rear arm section 110 by a pivot pin 140. A second end of the hydraulic cylinder 138 is disposed between, and pivotally coupled to, the tab 136 and outer corners of the parallel plates 113 of the intermediate arm section 112 by a pivot pin 142. When the hydraulic cylinder 138 is fully retracted, as shown in FIG. 3, the intermediate arm section 112 is pivoted counterclockwise a maximum amount about the articulation pin 114 and when the hydraulic cylinder 104 is fully extended, as shown in FIG. 5, the intermediate arm section 112 is pivoted clockwise a maximum amount about the articulation pin 114.

Mounted to the right- and left-hand arm assemblies 70 and 72, respectively, are right- and left-hand pivotal debarking knife assemblies 144 and 145. The knife assembly 144 includes a rear, intermediate and front pivotal knife segments 146, 148, and 150, respectively, having backsides illustrated here as being provided with parallel pairs of mounting ears 152, 154 and 156, noting that other configurations of mounting ears could be used as well. The pair of ears 152 of the rear knife segment 146 is positioned in straddling relationship to, and is pivotally mounted, as by a pivot bolt 158, to an inner region of the rear arm section 74 located between the sleeve 88 and articulation pin 78. The pair of ears 154 of the intermediate knife segment 148 is positioned in straddling relationship to, and is pivotally coupled, as by a pivot bolt 160, to an end region of the limb 82 of the V-shaped outer arm section 80. Similarly, the pair of ears 156 of the outer knife segment 150 is positioned in straddling relationship to, and is pivotally coupled, as by a pivot bolt 162, to an end region of the limb 84 of the outer arm section 80. In order to ensure that the knife segments 146, 148 and 150 remain free to pivot during operation, each of the pivot bolts 158, 160 and 162 is provided with a jam nut 164 (see FIGS. 1 and 2) which is screwed onto the stem of the bolt just to the point where it engages the adjacent blade mounting ear so that the pair of mounting ears are not tightly clamped to the associated arm section. A fixing nut 166 is then screwed into tight engagement with the jam nut 164. In other embodiments, the pivot bolts 158, 160 and 162 could be replaced with any suitable pivot pin or bolt connections respectively establishing pivot axes for the knife segments.

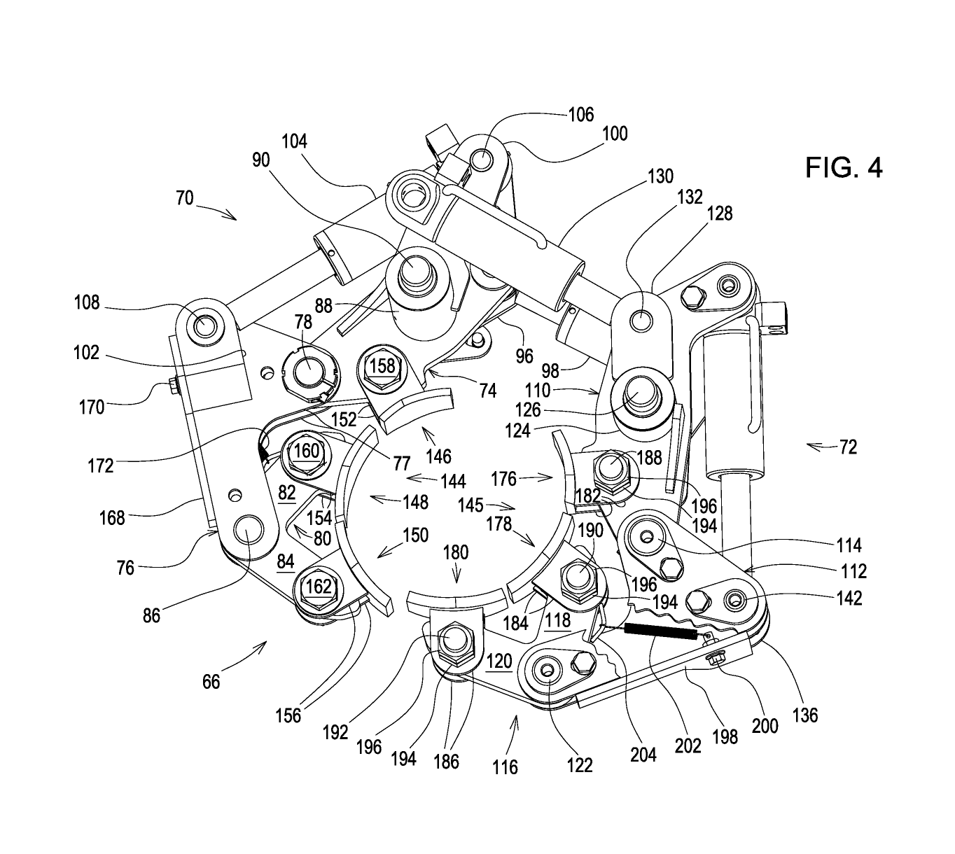

As will become more apparent from the following description, the pivotal mounting of the knife segments 146, 148 and 150 permits them to closely embrace and cover the circumference of a tree stem being debarked as the diameter of the stem varies when the stem moves along the feed axis 34. Also aiding in this operation is the articulated intermediate and front arm sections 76 and 80. In order to control the pivotal movement of the front arm section 80 about the pivot pin 86, a yieldable biasing mechanism is applied to the front arm section 80 so as to bias it counterclockwise about the pivot pin 86, as viewed in FIG. 4, for example, and hold it against the intermediate arm section 76 when the knife segments 148 and 150 are not in contact with a tree stem. A variety of yieldable biasing mechanisms could be employed. The specific biasing mechanism disclosed herein includes a spring anchor mounting 168, in the form of a strap, fixed along a side of each of the parallel plates 77 of the intermediate arm section 76 and an edge of the tab 102. A hole is provided in the spring anchor mounting 168 at a location below and on an opposite side of the arm section 76 from, the tab 102. A spring anchor 170 in the form of a bolt is inserted through the hole so that a stem (not shown) of the bolt extends below the arm section 76, with a nut (not shown) holding the anchor 170 in place. A drilled cross hole (not shown) receiving one end of a coil tension spring 172 is provided in an end region of the bolt. The other end of the spring 172 is engaged with a bent end 174 of a coil spring received about the pivot bolt 160. Thus, the spring 172 exerts a force resiliently resisting clockwise movement of the front arm section 80 about the articulation pin 86, with any force that may be exerted by a tree stem being delimbed on one or the other or both of the knife segments 148 and 150 in a direction tending to pivot the arm section 80 clockwise about the pivot pin 86 acting against the bias of the spring 172.

The left-hand pivotal debarking knife assembly 145 is basically a mirror image of the right-hand pivotal debarking assembly 144 and includes rear, intermediate and front pivotal knife segments 176, 178, and 180, respectively, having backsides provided with pairs of parallel mounting ears 182, 184 and 186. The pair of ears 182 of the rear knife segment 176 is positioned in straddling relationship to, and is pivotally mounted, as by a pivot bolt 188, to an inner region of the rear arm section 110 located between the sleeve 124 and articulation pin 126. The pair of ears 184 of the intermediate knife segment 178 are positioned in straddling relationship to, and are pivotally coupled, as by a pivot bolt 190, to an end region of the limb 118 of the V-shaped outer arm section 116. Similarly, the pair of ears 186 of the front knife segment 180 is positioned in straddling relationship to, and is pivotally coupled, as by a pivot bolt 192 to an end region of the limb 120 of the outer arm section 116. In order to ensure that the knife segments 176, 178 and 180 remain free to pivot during operation, each of the pivot bolts 188, 190 and 192 is provided with a jam nut 194 (see FIGS. 1 and 2) which is screwed onto the stem of the bolt just to the point where it engages the adjacent blade mounting ear so that the pair of mounting ears are not deflected and tightly clamped to the associated arm section. A fixing nut 196 is then screwed into tight engagement with the jam nut 194.

The pivotal mounting of the knife segments 176, 178 and 180 together with the articulated intermediate and front arm sections 112 and 116 permit the knife segments to closely embrace and cover the circumference of a tree stem being debarked as the diameter of the stem varies when the stem moves along the feed axis 34. In order to control the pivotal movement of the front arm section 116 about the pivot pin 122, a biasing arrangement is coupled between the intermediate and front arm sections which yieldably bias the front arm section clockwise towards the intermediate section. This biasing arrangement could take various forms but, like the biasing arrangement associated with right-hand arm sections 76 and 80, includes a spring anchor mounting 198, in the form of a strap fixed along outer sides of the parallel plates 113 (see FIG. 5) of the intermediate arm section 112 and one edge of the tab 136 (FIG. 5). A hole is provided in the spring anchor mounting 198 at a location between the parallel plates 113. A spring anchor in the form of a bolt 200 is inserted through the hole so that a stem of the bolt extends between the parallel plates 113. A nut 201 secures the bolt 200 in place. Provided in an end region of the bolt 200 for receiving a hook-shaped end of a coil tension spring 202 is a drilled cross hole. A hook-shaped second end of the spring 202 is engaged with a bent end 204 of a coil spring received about the pivot bolt 190. Thus, the spring 202 exerts a force resiliently resisting counterclockwise movement of the front arm section 116 about the articulation pin 122 when a tree stem being debarked exerts a force on one or the other or both of the knife segments 180 tending to rotate the outer arm section 112 counterclockwise about the pivot pin 122 in opposition to the action of the spring 202.

Assuming that the delimbing arms 16 and 18, and the wheel arms 58 and 60 of the harvesting head 10 are in a closed position clamping a tree stem so that the stem extends generally along the feed axis 34 and the axis 34 is generally horizontal, the tree stem will be in processing position. The length measuring wheel 33 will now be in a retracted position out of contact with the tree stem. Various means, for example a manually operated electrical switch (not shown) for coupling a control current to an electro-hydraulic control valve (also not shown), can be used to control the flow of hydraulic fluid to and from the hydraulic wheel control cylinder 38 so that it moves the wheel 33 to a deployed position wherein it engages the tree stem. Also, at this time, hydraulic fluid will have been routed for effecting the extension of the right- and left-hand hydraulic articulated arm control cylinders 98 and 130, and for effecting the extension of the right- and left-hand hydraulic articulated arm section control cylinders 104 and 138, this extension of the cylinders resulting in the knife segments 146, 148, 150, 176, 178 and 180 being held tightly against the tree stem. While other arrangements of debarking arm assemblies, debarking knife assemblies and power operated devices could be used to open and close the debarking knife segments relative to a tree stem, the illustrated debarking knife arrangement 66 is designed and sized for debarking trees having a diameter ranging from about 450 mm (18 in.) (see FIG. 4) to about 50 mm (2 in.) (see FIG. 5).

Because the debarking knife segments 146, 148, 150, 176, 178 and 180 are initially engaged with the top surface of the bark of the tree stem and the central feed wheel 40 has not traversed and cut or scored the bark, an initial procedure is performed to ensure that the knife segments penetrate the bark to the cambium layer of the tree stem. Further, this initial procedure is used to establish a reference point for cutting the tree stem into sections of equal length after being delimbed and debarked. This initial procedure is performed by manually effecting operation of motor control valves (not shown), for example electro-hydraulic direction control valves for respectively controlling the flow of fluid to and from reversible hydraulic motors (not shown) coupled for powering the feed wheels 40, 42 and 44. Assuming electro-hydraulic direction control valves are used, they are energized for causing the feed wheels to be rotated in a direction causing the tree stem to be pulled through the delimbing knife arrangement 13 and pushed through the debarking knife arrangement 66, with the pivotal knife segments 146, 148, 150, 176, 178 and 180 penetrating the bark as the stem passes under them. The length measurement wheel 33 will be rotated and when the length sensor associated with the wheel indicates that the tree stem has traveled a distance approximately equal to the spacing between the fixed delimbing knife 14 and the fixed debarking knife 68, an electrical signal will automatically be sent for actuating the motor control valves to reverse the flow of fluid to the feed wheel drive motors so as to reverse the direction of movement of the tree stem, with the cut end of the tree stem being sensed by any suitable tree butt or end sensing device as it nears a position just beyond a plane containing the chain saw bar 64. The tree end sensing device preferably generates a signal which indicates that the tree stem is positioned at a desired reference point for beginning the stem processing operation, this signal being used to automatically reset the length sensing circuitry to zero and to once again energize the wheel motor control valves for causing the feed wheels to be driven in the direction for pulling the stem through the delimbing knife arrangement 13 and pushing the stem through the debarking blade arrangement 66.

An automatic control system (not shown) then takes over operation of the processing functions. The operation of one such system is as follows: As the tree stem moves along the feed axis 34, the stem length measurement wheel 33 will once again rotate with the rotation sensor sending a signal from which the stem length passing the wheel 33 is determined. When the sensed length equals the log length desired, a stop feed signal will be sent causing interruption of the drive imparted to the feed wheels 40, 42 and 44, while at the same time sending a cut signal to the controlling device for the chain saw bar 64 which cycles the bar to cut off the log. A timing circuit is responsive to the cut signal to begin a timing sequence and times out when sufficient time has elapsed for the saw bar 64 to cycle. Upon timing out, a feed resume signal is sent for once again activating the motors driving the feed wheels 40, 42 and 44, with the above automatic procedure continuing until the tree stem size equals a predetermined minimum size that can be processed. A stop processing signal will then be sent to deactivate the motors driving the feed wheels and to cause the delimbing arm control cylinder 30 to be retracted so as to move the delimbing arms 16 and 18 to their fully open position shown in FIGS. 1 and 2, and to cause the debarking knife arrangement cylinders 104, 138, 98 and 130 to be retracted so as to move the knife assemblies 144 and 145 to their fully open position shown in FIG. 3.

It is to be noted, that during processing operation the orientation of the spirally ribbed feed wheels 40, 42 and 44 will result in the tree stem being rotated about the feed axis 34 while the right-hand knife segments 146, 148 and 150, and the left-hand knife segments 176, 178 and 180 move toward each other as the tree diameter diminishes.

One feature of the debarking knife arrangement 66 which results in the knife segments keeping in close contact is their respective pivotal mountings to the right- and left-hand articulated debarking arm assemblies 70 and 72 which permits the segments to pivot as they pass over Irregularities of the surface of the stem engaged by the knife segments and thus cleanly scrape the bark off the stem. Full coverage of the stem surface by the knife segments is aided by the fact that the stem is being rotated at the same time that it is being fed linearly. However, it is noted that the debarking knife arrangement 66 will remove approximately 95% of the bark without rotation of the tree stem so that the tree stem feed wheels need not be constructed and/or oriented to cause the tree stem to rotate.

Another feature aiding in the knife segments maintaining close contact with the stem is that of the arm assemblies 70 and 72 supporting the knife segments being articulated. For example, considering the right-hand delimbing arm assembly 70 in the closed position shown in FIG. 4, it will be appreciated that, as the stem diminishes in diameter, the cylinder 98 will extend to cause the rear arm section 74 to rotate counterclockwise about the fixed pivot post 90 thereby keeping the knife segment 146 in contact with the stem. At the same time, the hydraulic cylinder 104 will likewise extend to cause the intermediate arm section 76 to be pivoted counterclockwise about the articulation pin 78 so that the knife segments 148 and 150 carried by the V-shaped front arm section 80 are maintained in contact with the stem. The tension spring 172 is coupled between the front and intermediate arm sections 80 and 76, respectively, so as to yieldably bias the front arm section counterclockwise about the articulation pin 86 and keep the knife segments 148 and 150 properly oriented for engagement with the tree stem, noting that clockwise moments exerted on the front arm section 80 by the tree stem engaging the knife segments 148 and 150 will be resisted by the spring 172.

At some point before the debarking knife arrangement reaches the fully closed position shown in FIG. 5, the knife segment 150 will move so as to no longer contact the stem but rather be positioned under the rear arm section 110 of the left-hand arm assembly 72 (the knife segment 150 is not visible in FIG. 5 but would be positioned relative to sleeve 124 similarly to the position of the knife segment 180 to the sleeve 88.

Operation of the left-hand articulated debarking arm assembly 72 is similar to that stated above for the right-hand articulated debarking arm assembly 70 and is omitted for the sake of brevity.

While a preferred embodiment of the disclosure has been illustrated and described in detail in the drawings and foregoing description, such illustrations and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all the features described yet still benefit from at least some of the advantages of such features. Those of ordinary skill in the art may readily devise their own implementations that incorporate one or more of the features of the present disclosure without departing from the spirit and scope of the present invention as defined in the accompanying claims.

The invention claimed is:

1. A tree stem processing head comprising a frame, a tree stem grasping arrangement for holding a tree stem against the frame and along a feed axis, a tree stem debarking knife arrangement mounted to the frame, a tree stem feed arrangement for moving the stem along the feed axis relative to the frame and to the debarking knife arrangement, wherein said debarking knife arrangement comprises:
a) right- and left-hand debarking arm assemblies respectively mounted on opposite sides of said feed axis for being pivoted about right- and left-hand pivot posts that are fixed to the frame;
b) a plurality of debarking knife segments being individually pivotally mounted to each of said right- and left-hand debarking arm assemblies for pivoting about respective axes extending at least substantially parallel to said feed axis, with said plurality of knife segments being so arranged relative to each other that said plurality of debarking knife segments cooperate with each other to closely embrace a tree stem located along the feed axis with near complete circumferential coverage independent of stem diameter when the right- and left-hand debarking arm assemblies are pivoted toward each other; and
c) a powered arm control arrangement being coupled to said right- and left-hand debarking arm assemblies for selectively causing said right- and left-hand debarking arm assemblies to pivot towards and away from each other.

2. The tree stem processing head, as defined in claim 1, wherein said right- and left-hand debarking arm assemblies respectively include right- and left-hand rear arm sections mounted for pivoting about said right- and left-hand pivot posts, and further respectively include right- and left-hand front arm sections respectively pivotally coupled to the right- and left-hand rear arm sections, with said plurality of debarking knife segments including at least a rear knife segment mounted to each of said right- and left-hand rear arm sections, and wherein said powered arm control arrangement is coupled for pivoting said right- and left-hand front arm sections relative to said right- and left-hand rear arm sections.

3. The tree stem processing head, as defined in claim 2, wherein, in addition to said right- and left-hand front arm sections, said right and left-hand delimbing arm assemblies arm sections respectively include right- and left-hand intermediate arm sections respectively having pivotal connections with the right-hand rear and front arm sections, and with the left-hand front and rear arm sections.

4. The tree stem processing head, as defined in claim 3, wherein said powered arm control arrangement is coupled so as to effect rotation of said right- and left-hand intermediate arm sections about the respective pivotal connections of the right- and left-hand intermediate arm sections with said right- and left-hand rear arm sections and thereby respectively pivot the right- and left-hand front arm sections relative to the right- and left-hand rear arm sections.

5. The tree stem processing head, as defined in claim 3, and further including right- and left-hand biasing assemblies respectively coupled for acting between said right-hand front arm section and the right-hand intermediate arm section, and between said left-hand front arm section and said left-hand intermediate arm section so as to respectively yieldably resist pivotal movement of the right-hand front arm section away from said right-hand intermediate arm section, and yieldably resist pivotal movement of said left-hand front arm section away from said left-hand intermediate arm section, thereby maintaining the at least two debarking knife segments carried by each of the right- and left-hand front arm sections in favorable positions for contacting and debarking a tree stem as the tree stem diameter decreases as the stem moves along the feed axis.

6. The tree stem processing head, as defined in claim 3, wherein said right- and left-hand front arm sections are each V-shaped, with a pair of limbs diverging toward said feed axis, with said at least two debarking knife segments associated with said right-hand front arm segment being respectively pivotally mounted to ends of the pair of limbs of the right-hand front arm segment, and with said at least two debarking knife segments associated with said left-hand front arm segment being respectively pivotally mounted to ends of the pair of limbs of the left-hand arm segment; and with the right- and left-hand intermediate arm sections being respectively pivotally coupled to the right- and left-hand front arm sections at a region of divergence of the pair of limbs.

7. The tree stem processing head, as defined in claim 6, and further including right- and left-hand biasing assemblies respectively coupled for acting between said right-hand front arm section and the right-hand intermediate arm section, and between said left-hand front arm section and said left-hand intermediate arm section so as to respectively yieldably resist pivotal movement of the right-hand front arm section away from said right-hand intermediate arm section, and yieldably resist pivotal movement of said left-hand front arm section away from said left-hand intermediate arm section, thereby maintaining the at least two debarking knife segments carried by each of the right- and left-hand front arm sections in favorable positions for contacting and debarking a tree stem as the tree stem diameter decreases as the stem moves along the feed axis.

8. The tree stem processing head, as defined in claim 7, wherein said right- and left-hand biasing assemblies respectively include a right-hand coil tension spring coupled between one limb of the right-hand front arm section and the right-hand intermediate arm section, and a left-hand coil tension spring coupled between one limb of the left-hand front arm section and the left-hand intermediate arm section.

9. The tree stem processing head, as defined in claim 1, wherein said powered arm control arrangement includes a hydraulic cylinder arrangement.

10. The tree stem processing head, as defined in claim 9, wherein said hydraulic cylinder arrangement includes right- and left-hand hydraulic arm control cylinders respectively coupled to said right- and left-hand debarking arm assemblies for selectively causing said right and left-hand debarking arm assemblies to pivot towards and away from each other.

11. The tree stem processing head, as defined in claim 10, wherein said right- and left-hand debarking arm assemblies respectively include right- and left-hand rear arm sections mounted for pivoting about said right- and left-hand pivot posts, and further respectively include right- and left-hand front arm sections respectively pivotally coupled to the right- and left-hand rear arm sections, with said plurality of debarking knife segment including at least a rear knife segment pivotally mounted to each of said right- and left-hand rear arm sections and includes at least two further debarking knife segments pivotally mounted to each of said right- and left-hand front arm sections, and wherein said right-hand hydraulic arm control cylinders include a first right-hand hydraulic cylinder coupled for pivoting the right-hand rear arm section about said right-hand pivot post and a second right-hand hydraulic cylinder coupled for pivoting the right-hand front arm section about its pivotal connection with the right-hand rear arm section, and wherein said left-hand hydraulic arm control cylinders include a first left-hand hydraulic cylinder coupled for pivoting the right-hand rear arm section about said left-hand pivot post and a second left-hand hydraulic cylinder coupled for pivoting the left-hand front arm section about its pivotal connection with the left-hand rear arm section.

12. The tree stem processing head, as defined in claim 11, wherein, in addition to said right- and left-hand front arm sections, said right- and left-hand intermediate arm sections, said right- and left-hand debarking arm assemblies respectively include right- and left-hand intermediate arm sections, with the right-hand intermediate arm section having opposite ends respectively pivotally connected to the right-hand rear arm section and the right-hand front arm section, and with the left-hand intermediate arm section having opposite ends respectively pivotally connected to the left-hand rear arm section and left-hand front arm section, and wherein said second right-hand hydraulic cylinder is coupled between the right-hand rear arm section and the right-hand intermediate arm section, and wherein said second left-hand hydraulic cylinder is coupled between the left-hand rear arm section and the left-hand intermediate arm section.
